(19) United States
(12) Patent Application Publication
(10) Pub. No.: US 2025/0305559 A1
(43) Pub. Date: Oct. 2, 2025

(54) THREADED PIN ASSEMBLY FOR ENGINEERED CLASS CHAIN

(71) Applicant: Webster Industries, Inc., Tiffin, OH (US)

(72) Inventors: William Rennels, Tiffin, OH (US); Brian Cline, Alvada, OH (US); Nathan Curry, Van Buren, OH (US)

(21) Appl. No.: 19/095,456

(22) Filed: Mar. 31, 2025

Related U.S. Application Data
(60) Provisional application No. 63/571,503, filed on Mar. 29, 2024.

(51) Int. Cl. F16G 15/04

(52) U.S. Cl. CPC F16G 15/04

(57) ABSTRACT

A threaded pin assembly for a chain having a first link and a second link is provided. The threaded pin assembly can include a threaded pin, a spacer, a thrust washer, and a threaded fastener. The threaded pin can have a head at a first end, a threaded portion at a second end, a body portion disposed between the head and the threaded portion, and a pin shoulder disposed between the body portion and the threaded portion. A method of coupling a first link of a chain to a second link of the chain using the threaded pin assembly is also provided. The threaded pin assembly for linking individual chain links together offers a quick, cost-effective, and straightforward solution for both assembly and repair.

### CROSS-REFERENCE TO RELATED APPLICATIONS

This application claims the benefit of U.S. Provisional Application No. 63/571,503, filed on Mar. 29, 2024. The entire disclosure of the above application is incorporated herein by reference.

### FIELD

The present technology relates to an engineered chain assembly composed of interconnected chain links. More specifically, the present technology relates to a threaded pin assembly for linking chain links together.

### INTRODUCTION

This section provides background information related to the present disclosure which is not necessarily prior art.

An engineered class chain is a type of chain used in conveyor and bucket elevator applications for transporting materials from one location to another. The engineered class chain can include a series of interconnected links. The links can include opposing side links with short cylinders, or barrels, disposed therebetween. A rivet passing through the short cylinder can be used to join one link to another. A toothed wheel, referred to as a sprocket, can be used to drive the engineered class chain and facilitate movement of the associated conveyor. Advantageously, the engineered class chain can provide a simple, reliable, and efficient means of driving a conveyor and bucket elevator.

One example of an engineered class chain is a welded steel mill chain, which can be used in industrial manufacturing and process lines. Additional applications of welded steel mill chains can include metal fabrication facilities, material feeding systems, scrap metal handling equipment, ladle and tundish operations, slag removal, pot handling, and similar operations. Welded steel mill chains can be formed from medium-carbon or alloy steel, in grades that provide high strength, wear resistance, and temperature tolerance.

Welded steel mill chains can have a high tensile strength rating and can be case-hardened or through-hardened. The high tensile strength rating can enable the chains to support the heavy loads frequently encountered in industrial plants, metal fabrication facilities, and steel mills. Case hardening or through hardening can provide a hardened surface layer that enhances wear resistance and durability. Hardness levels can be selected based on the specific application. Welded steel mill chains can be constructed by forming individual links and welding them together at the joints. This welded construction can reduce costs compared to chains formed from forged links. In certain instances, welded steel mill chains can include specially designed links to enhance performance for specific applications. Various coatings and lubricants can also be applied to improve corrosion resistance and reduce friction. While engineered class chains can provide advantages such as heat resistance, wear resistance, and cost efficiency, their assembly and repair can be labor-intensive, time-consuming, expensive, and difficult.

Assembly of engineered class chains can be a labor-intensive and time-consuming process. Engineered class chains can include specially designed pins, barrels, and plates that can require a certain alignment and securement to ensure optimal performance. The assembly process can require specialized tools and equipment, as well as skilled technicians with experience handling these types of engineered class chains. Complexity of the design means that it may be required to property position each link, where misalignment during assembly can lead to premature wear, decreased efficiency, or even failure under load. Additionally, some engineered class chains require heat-treated or coated components, which may necessitate additional handling precautions or assembly techniques to avoid damaging critical surfaces.

When it comes to repairs, the challenges become even more pronounced. Disassembling a worn or damaged engineered class chain can be difficult, as corrosion, debris, or material fatigue can cause components to seize or become deformed, making them difficult to separate without damaging adjacent links. Replacing individual components can require matching exact specifications, which can be complicated if the original manufacturer has discontinued certain parts or if minor variations in design affect compatibility. In some cases, repairs must be conducted in specialized facilities rather than in the field, adding logistical costs and downtime to the overall maintenance process. Moreover, since engineered class chains are used in demanding applications, such as industrial conveyors, mining equipment, or high-temperature environments, any delay in repair can result in significant operational disruptions, further increasing costs.

Accordingly, there is a continuing need for a way for linking individual chain links together that is quick, cost-effective, and straightforward to assemble and repair.

### SUMMARY

In concordance with the instant disclosure, a threaded pin assembly for linking individual chain links together that is quick, cost-effective, and straightforward to assemble and repair, has surprisingly been discovered. The present technology includes articles of manufacture, systems, and processes that relate to a threaded pin assembly for linking chain links together.

In certain embodiments, a threaded pin assembly for a chain having a first link and a second link is provided. The threaded pin assembly can include a threaded pin having a head at a first end, a threaded portion at a second end, a body portion disposed between the head and the threaded portion, and a pin shoulder disposed between the body portion and the threaded portion. The threaded pin assembly can include a spacer configured to be disposed on the threaded pin from the second end. The spacer can include a tapered aperture configured to abut the pin shoulder of the threaded pin and limit travel of the spacer on the threaded pin toward the head. The threaded pin assembly can include a thrust washer configured to be disposed on the threaded pin from the second end. The threaded pin assembly can include a threaded fastener configured to threadably engage the threaded portion.

In certain embodiments, a chain is provided. The chain can include a first link including a barrel, a first barrel aperture, and a second barrel aperture, and a second link including a first aperture and a second aperture. The chain can include a threaded pin having a head at a first end, a threaded portion at a second end, a swell neck disposed adjacent the head, a body portion disposed between the swell neck and the threaded portion, and a pin shoulder disposed between the body portion and the threaded portion, the pin shoulder can include an aperture configured to receive a cotter pin. The chain can include a spacer configured to be disposed on the threaded pin from the second end. The spacer can include a tapered aperture configured to abut the pin shoulder of the threaded pin and limit travel of the spacer on the threaded pin toward the head. The chain can include a thrust washer configured to be disposed on the threaded pin from the second end. The chain can include a threaded fastener configured to threadably engage the threaded portion. The threaded pin can be configured to be received through the first barrel aperture, the barrel, and the second barrel aperture of the first link, and the first aperture and the second aperture of the second link. The swell neck can fit in one of the first aperture and the second aperture of the second link assembly and an end of the spacer can confront a surface around the other of the first aperture and the second aperture of the second link assembly.

In certain embodiments, a method for coupling a first link of a chain to a second link of the chain is provided. The first link can include a barrel, a first barrel aperture, and a second barrel aperture, and the second link can include a first aperture and a second aperture. The method can include a step of providing a threaded pin assembly as described herein. The method can include a step of aligning the barrel apertures of the second link and the first aperture and the second aperture of the first link and inserting the threaded pin therethrough. The method can include a step of disposing the spacer on the threaded pin. The method can include a step of disposing the thrust washer on the threaded pin. The method can include a step of threadably engaging the threaded fastener with the threaded pin. The method can include a step of tightening the threaded fastener on the threaded pin. The step of tightening the threaded fastener can result in the threaded pin being pulled through the barrel aperture until the head substantially abuts one of the first aperture and the second aperture of the second link.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of a first link and a second link of an engineered class chain;

FIG. 2 is a perspective view of a threaded pin assembly showing a threaded pin, a spacer, a thrust washer, a threaded fastener, and a cotter pin, according to an embodiment of the present disclosure;

FIG. 3 is a plan view of the threaded pin, according to the embodiment shown in FIG. 2;

FIG. 4 is a top perspective view of the spacer, according to the embodiment shown in FIG. 2

FIG. 5 is bottom perspective view of the spacer, according to the embodiment shown in FIG. 2;

FIG. 6 is a cross-sectional view of the spacer, according to the embodiment shown in FIG. 2;

FIG. 7 is an exploded plan view of the first link and the second link of the engineered class chain, and the threaded pin assembly, according to the embodiments shown in FIGS. 1 and 2;

FIG. 8 is an exploded perspective view of the first link and the second link of the engineered class chain, and the threaded pin assembly, according to the embodiments shown in FIGS. 1 and 2;

FIG. 9 is a perspective view of the threaded pin and cotter pin installed in the first link and the second link of the engineered class chain, according to the embodiments shown in FIGS. 1 and 2; and

FIGS. 10, 11, and 12 provide a flow chart illustrating a method of coupling a first link of a chain to a second link of the chain using a threaded pin assembly, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In accordance with the present disclosure, a threaded pin assembly 100, an engineered class chain 10, and a method 200 for coupling a first link 12 of a chain 10 to a second link 14 of the chain 10 are provided. Advantageously, the present disclosure addresses shortcomings in engineered class chains 10 by providing a threaded pin assembly 100 for use in assembly of an engineered class chain 10 that can enable the linking of chain links that is quick, cost-effective, and straightforward to assemble and repair. The present disclosure minimizes the need for specialized tools and equipment, reduces reliance on specially skilled technicians, and decreases operational disruptions.

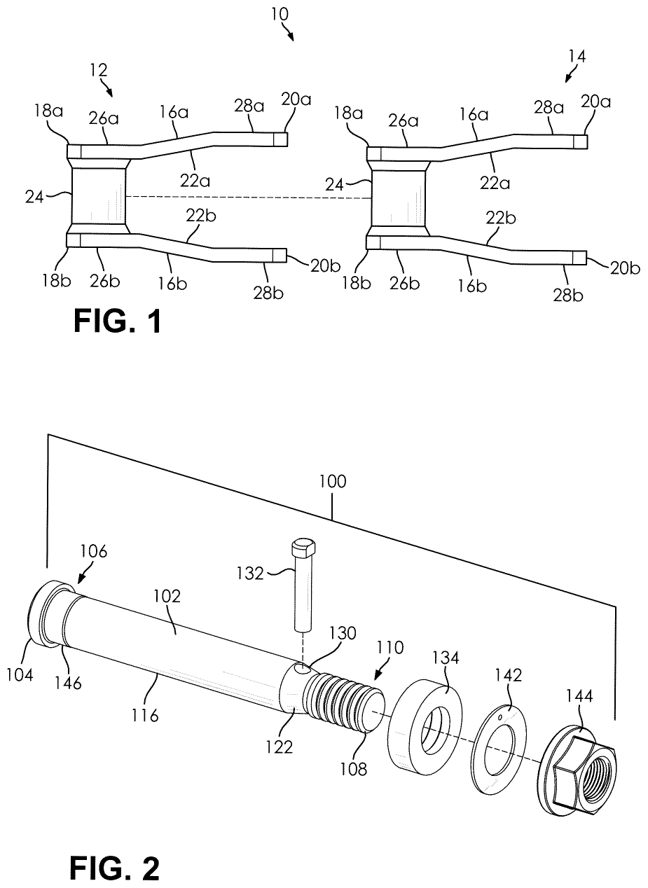

Referring now to the drawings, illustrated in FIG. 1 is a simplified view of aspects used construction of an engineered class chain 10 (referred to herein as a “chain”). The chain 10 can be constructed in various ways, as known to one skilled in the art. The chain 10 can include a first link 12 and a second link 14. Each of the first link 12 and the second link 14 can include sidebars 16, which can include a first sidebar 16a and a second sidebar 16b. The sidebars 16a and 16b can have various shapes, including straight, bent, block-and-bar, or open-barrel pintle configurations.

The sidebars 16 can include necked-down portions 18, including a first necked down portion 18a and a second necked down portion 18b, respectively. The sidebars 16 can include flared portions 20, including a first flared portion 20a and a second flared portion 20b. The sidebars 16 can include intermediate portions 22, including a first intermediate portion 22a and a second intermediate portion 22b, which can connect the necked-down portions 18 and flared portions 20. The sidebars 16 can be of a unitary construction, formed as a single, continuous piece. Alternatively, the sidebars 16 can be composed of separate pieces that are joined together through fastening methods such as welding, bolting, or riveting.

Each of the first link 12 and the second link 14 can include a barrel 24, which can be disposed between the necked-down portions 18a, 18b of the sidebars 16a, 16b. The sidebars 16a, 16b and the barrel 24 can be of a unitary construction, formed as a single, continuous piece. Alternatively, the sidebars 16a, 16b and the barrel 24 can be composed of their constituent pieces that are joined together through fastening methods such as welding, bolting, or riveting.

Each of the sidebars 16a, 16b can include barrel apertures 26a, 26b formed in the necked-down portions 18a, 18b that is in substantial axial alignment with the barrel 24. The barrel apertures 26a, 26b and the barrel 24 can form a passageway (not shown) for receiving connecting elements such as pins, rivets, or cotter keys, which can be used to assemble and secure chain links. Additionally, each of the sidebars 16a, 16b can include a first aperture 28a and a second aperture 28b formed in the flared portions 20a, 20b. Additionally, while the engineered class chain 10 is illustrated in simplified form, it can include additional structural elements, such as an attachment (not shown), as used in the art.

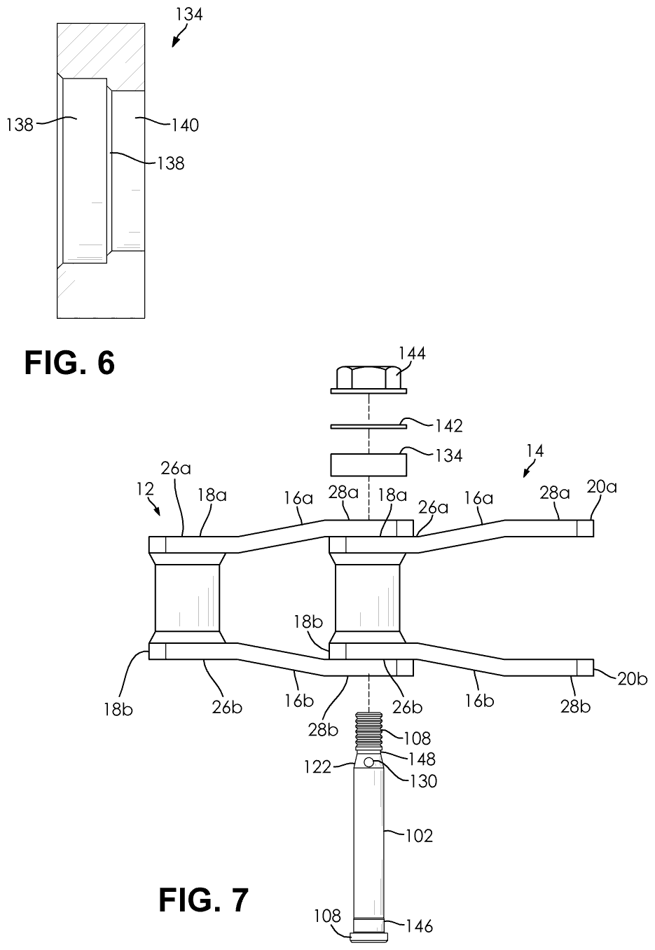

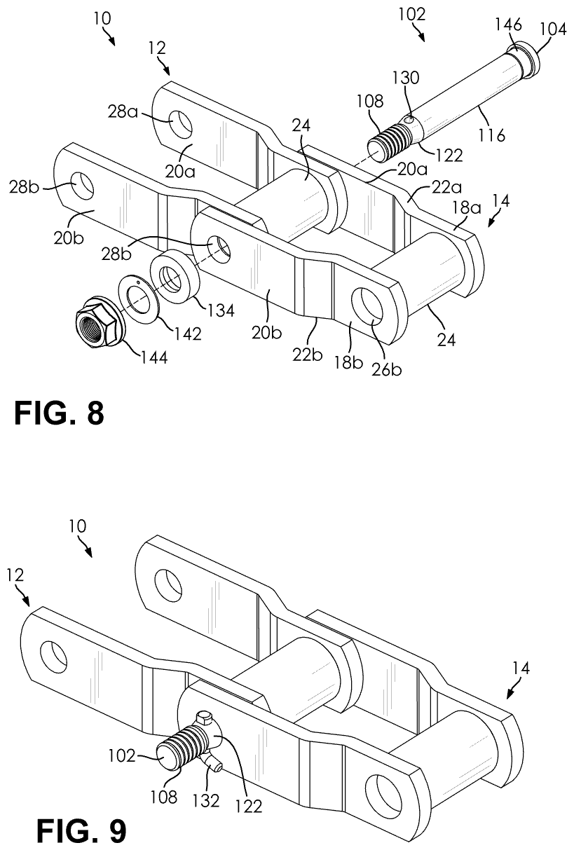

In certain embodiments, and with reference to FIGS. 2-9, a threaded pin assembly 100 for a chain 10 having a first link 12 and a second link 14, the first link 12 including a barrel 24, a first barrel aperture 26a, and a second barrel aperture 26b, and the second link 14 including a first aperture 28a and a second aperture 28b, can include a threaded pin 102. The threaded pin 102 can include a head 104 at a first end 106 and a threaded portion 108 at a second end 110. The head 104 can have a diameter larger than a diameter of one of the first aperture 28a and the second aperture 28b of the second link 14. The diameter can prevent the head 104 from passing through the apertures 28a, 28b.

The threaded pin 102 can include a body portion 116 disposed between the head 104 and the threaded portion 108. The body portion 116 can have a length 118 that is substantially the same as the length of the passageway formed by the barrel 24, the first barrel aperture 26a, and the second barrel aperture 26b of the first link 12, as well as the first aperture 28a and the second aperture 28b of the second link 14. The length 118 can ensure that the body portion 116 extends fully through the passageway, providing a continuous connection between the chain links 12, 14. By extending through the entire passageway, the body portion 116 can militate against axial shifting or play.

Additionally, the body portion 116 can have a diameter that is substantially the same as a diameter of one of the first aperture 28a and the second aperture 28b. This close dimensional match can create a slip fit when the body portion 116 is inserted into one of the first aperture 28a and the second aperture 28b, promoting alignment and minimizing unwanted movement. The fit can also help evenly distribute loads across the apertures 28a, 28b, reducing localized stress concentrations and militating against the risk of material deformation or fatigue over time. It can also reduce wear, improve load transfer, and maintain the proper alignment of the chain links, even under demanding operating conditions.

The threaded pin 102 can include a pin shoulder 122 disposed between the body portion 116 and the threaded portion 108. The pin shoulder 122 can include a tapered transition 124 from a first diameter 126 to a second diameter 128, with the second diameter 128 being smaller than the first diameter 126. The tapered transition 124 can help evenly distribute stress, reducing the likelihood of fatigue or localized deformation during installation. The threaded pin 102 can further include an aperture 130 configured to receive a cotter pin 132. The aperture 130 can be disposed on the pin shoulder 122. By positioning the aperture 130 on the pin shoulder 122, the cotter pin 132 can help militate against unintentional loosening or backing off of the threaded fastener 144 during operation.

With reference to FIGS. 4-6, the threaded pin assembly 100 can include a spacer 134 designed to be positioned on the threaded pin 102 from the second end 110. The spacer 134 can include a tapered aperture 136 defined by a first diameter 138 and a second diameter 140, where the first diameter 138 is larger than the second diameter 140. The tapered aperture 136 can feature a conical or frustoconical profile, gradually decreasing in width from the first diameter 138 to the second diameter 140. Alternatively, the tapered aperture 136 can be stepped, consisting of a series of discrete diameter reductions, creating a tiered profile. It should be understood that one having ordinary skill in the art can select a suitable tapered profile, angle, or step configuration for the tapered aperture 136 within the scope of the present disclosure. When positioned on the threaded pin 102, the tapered aperture 136 can abut and rest against the pin shoulder 122 and limit travel of the spacer 134.

The threaded pin assembly 100 can include a thrust washer 142. The thrust washer 142 can be configured to be disposed on the threaded pin 102 from the second end 110. The thrust washer 142 can serve as a bearing surface, reducing friction between rotating or sliding components during operation or installation. The thrust washer 142 can help distribute axial loads evenly, militating against localized wear. The thrust washer 142 can be made from various materials, such as hardened steel, bronze, or self-lubricating composites, to enhance durability and performance under different operating conditions. The thrust washer 142 can feature a smooth or textured surface to optimize load distribution and minimize galling or seizing. In some configurations, the thrust washer 142 can include a low-friction coating, where the coating can include one or more materials such as molybdenum disulfide and polytetrafluoroethylene (PTFE), to minimize friction forces.

The threaded pin assembly 100 can include a threaded fastener 144 configured to threadably engage the threaded portion 108. The threaded fastener 144 can function as a securing element, applying axial clamping force to pull the threaded pin assembly 100 components together. By threading onto the threaded portion 108, the threaded fastener 144 can draw the threaded pin 102 through the barrel 24 and the corresponding barrel apertures 26a, 26b of the second link 14, and the first aperture 28a and the second aperture 28b of the first link 12 creating a secure connection between the first link 12 and the second link 14. When tightened on the threaded pin 102, the threaded fastener 144 can create a compressive force that securely pulls the threaded pin 102 so that the head 104 substantially abuts one of the first aperture 28a and the second aperture 28b.

The threaded fastener 144 can be of various types, including a flange nut, hex nut, locknut, or cap nut, depending on the application requirements. It can feature standard or fine threading to provide the appropriate balance of holding strength and ease of installation. The threaded fastener 144 can also include a locking mechanism, such as a nylon insert or deformed thread pattern, to resist loosening caused by vibration or dynamic loads, enhancing the overall reliability of the threaded pin assembly 100. In certain embodiments, the threaded fastener 144 can be made from durable materials such as hardened steel or stainless steel to withstand high tensile forces and resist corrosion. The threaded fastener 144 can also include a protective coating, such as zinc plating or galvanizing, to enhance resistance to rust and environmental wear.

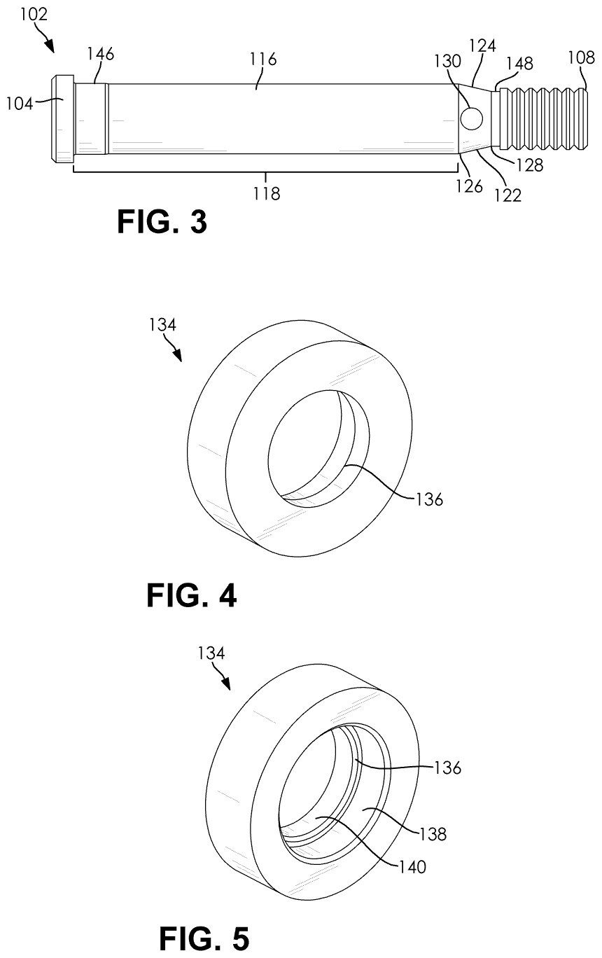

In certain embodiments, and with reference to FIGS. 2-3, the threaded pin 102 can include a swell neck 146. The swell neck 146 can be disposed between the head 104 and the body portion 116. The swell neck 146 can have a slightly larger diameter than the body portion 116, creating an interference fit when inserted into one of the first aperture 28a and the second aperture 28b of the first link 12.

The diameter of the swell neck 146 is designed to be slightly larger than the first aperture 28a and second aperture 28b of the first link 12, requiring the application of force during installation of the threaded pin assembly 100. As the swell neck 146 is pulled into one of the first aperture 28a and second aperture 28b, it can cause a slight deformation or expansion of the aperture walls, creating a tight, friction-based connection. This interference fit can help militate against unintended movement or rotation of the threaded pin 102, helping to lock the threaded pin 102 in place and resist loosening due to vibration, tension, or operational forces.

The interference fit provided by the swell neck 146 can also enhance the overall stability and structural integrity of the threaded pin assembly 100. By securely anchoring the threaded pin 102 within one of the first aperture 28a and the second aperture 28b, the interference fit can reduce axial and radial play, helping consistent positioning and alignment of the chain links. This can be particularly beneficial in high-load or high-stress applications, as it minimizes the risk of pin slippage or misalignment, which could otherwise lead to uneven wear or mechanical failure. Additionally, the swell neck 146 can distribute load more evenly across one of the first aperture 28a and the second aperture 28b of the first link 12, reducing localized stress concentrations that could cause material fatigue or elongation of the apertures 28a, 28b over time. This load distribution can extend the service life of the chain links.

In certain embodiments, and with reference to FIGS. 3 and 7, the threaded pin 102 can include a relief groove 148. The relief groove 148 can be formed on the threaded portion 108 of the threaded pin 102. This groove can be a shallow, recessed channel cut into the threaded section, creating a localized reduction in diameter. The relief groove 148 can serve multiple purposes. It can help reduce stress concentrations by providing a transition point between the threaded portion 108 and the body portion 116. Additionally, the relief groove 148 can facilitate easier disassembly of the threaded pin 102 by reducing the thread engagement surface area. This can make it simpler to unthread the threaded fastener 144, particularly in high-torque or heavily loaded applications. The presence of the groove can also enhance the flexibility of the threaded portion 108, accommodating slight deformations without compromising the integrity of the connection.

The relief groove 148 can also be advantageous in situations where the threaded portion 108 needs to be removed for the continued operability of the chain 10. If the threaded portion 108 becomes damaged, bent, or obstructive, the relief groove 148 can serve as a convenient fracture or cut point. By providing a thinner cross-section, the relief groove 148 can make it easier to cleanly shear or cut away the threaded portion 108 without damaging the remaining components of the chain 10. This feature can enable quicker field repairs or modifications, minimizing downtime and ensuring the chain remains functional.

In certain embodiments, the threaded pin 102 can include a coating. The coating can be configured to minimize friction and heat generated by the threaded pin 102 during installation. The tolerances between the barrel apertures 26 and the first and the second apertures 28a, 28b can be sufficient tight, making installation of the threaded pin 102 difficult or impossible without the coating. The close fit between the threaded pin 102 and the barrel apertures 26 and the first and the second apertures 28a, 28b can create significant resistance as the threaded pin 102 is pulled through the barrel apertures 26 and the first aperture 28a and the second aperture 28b. Without the coating, the friction from the tight tolerances can generate excessive heat during installation, which can lead to thermal expansion of the respective components. This thermal expansion can further tighten the fit, resulting in the binding and/or fusing of the threaded pin 102 to the barrel apertures 26 and first aperture 28a and the second aperture 28b. Without the coating, the friction created when pulling the threaded pin 102 through the first link 12 and the second link 14 can potentially seize the chain assembly making disassembly or repair significantly more difficult.

The coating can comprise one or more of the following materials: molybdenum disulfide, grease, graphite, polytetrafluoroethylene (PTFE), boron nitride, and tungsten disulfide. Molybdenum disulfide can provide superior lubrication and reduce wear, especially under high-pressure conditions. Grease and graphite can further reduce friction while also providing some level of corrosion resistance. PTFE is known for its low friction properties and can provide a smooth surface that minimizes heat generation. Boron nitride can offer both lubricating properties and excellent thermal conductivity, helping to dissipate heat. Tungsten disulfide is another material with excellent lubrication properties, particularly effective in high-temperature environments.

The coating can be applied using various methods, including brushing, spraying, dipping, or electrostatic deposition, depending on the specific material and desired coating thickness. In certain embodiments, a liquid coating can be applied by brushing the coating material onto a surface of the threaded pin 102. Following application of the coating, the threaded pin 102 can be placed in an oven or other drying environment and cured at a pre-determined temperature for a pre-determined duration. The curing process can allow the coating to bond with the surface of the threaded pin 102, creating a durable, low-friction layer. The curing process can also help the coating achieve a more uniform adhesion, preventing flaking or uneven coverage. By using such coatings, the threaded pin 102 can improve the ease of installation and removal, be better protected against wear, and ensure the smooth movement of the chain links during operation. The coating can also help to maintain optimal performance in high-stress environments where heat and friction are problematic.

In certain embodiments, and with reference to FIGS. 7-9, an engineered class chain 10 (or more simply “chain 10”) is provided. The chain 10 can include a first link 12 having a barrel 24, a first barrel aperture 26a, and a second barrel aperture 26b. The chain 10 can further include a second link 14 having a first aperture 28a and a second aperture 28b. The chain 10 can include a threaded pin 102, a spacer 134, a thrust washer 142, and a threaded fastener 144 each as described hereinabove.

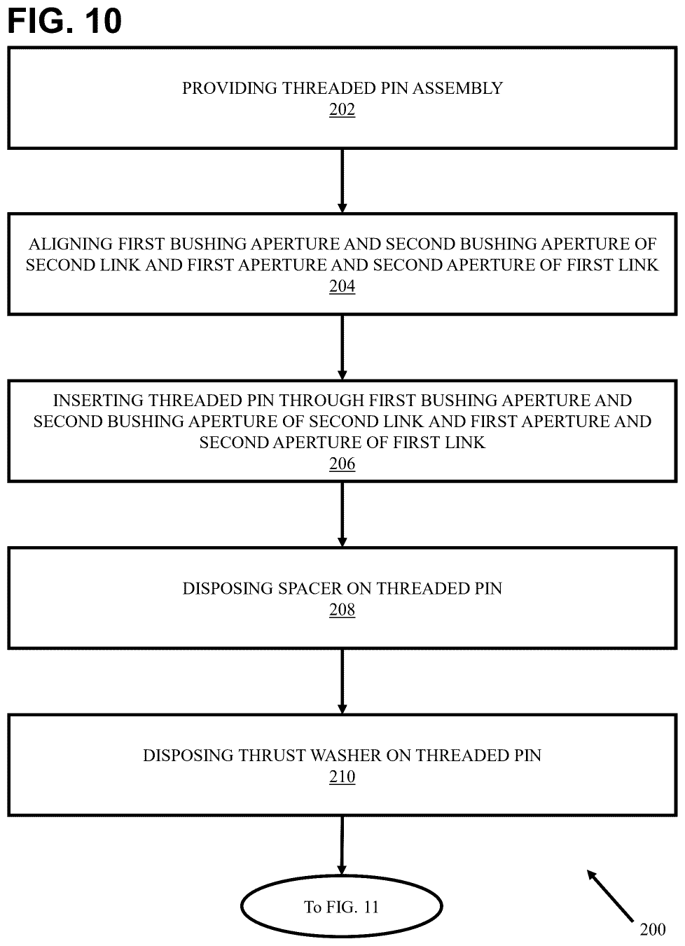

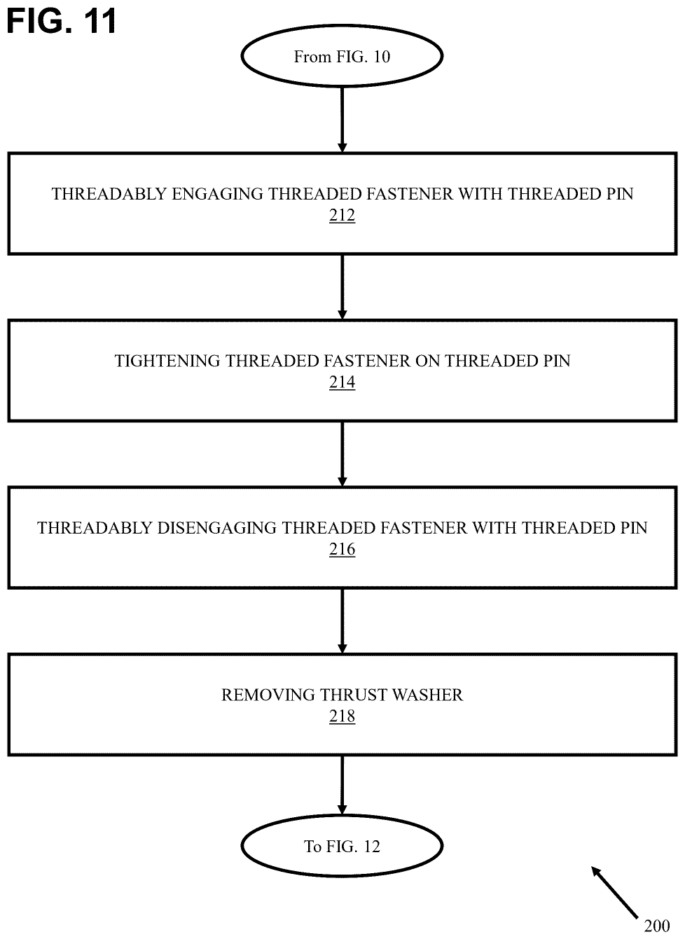

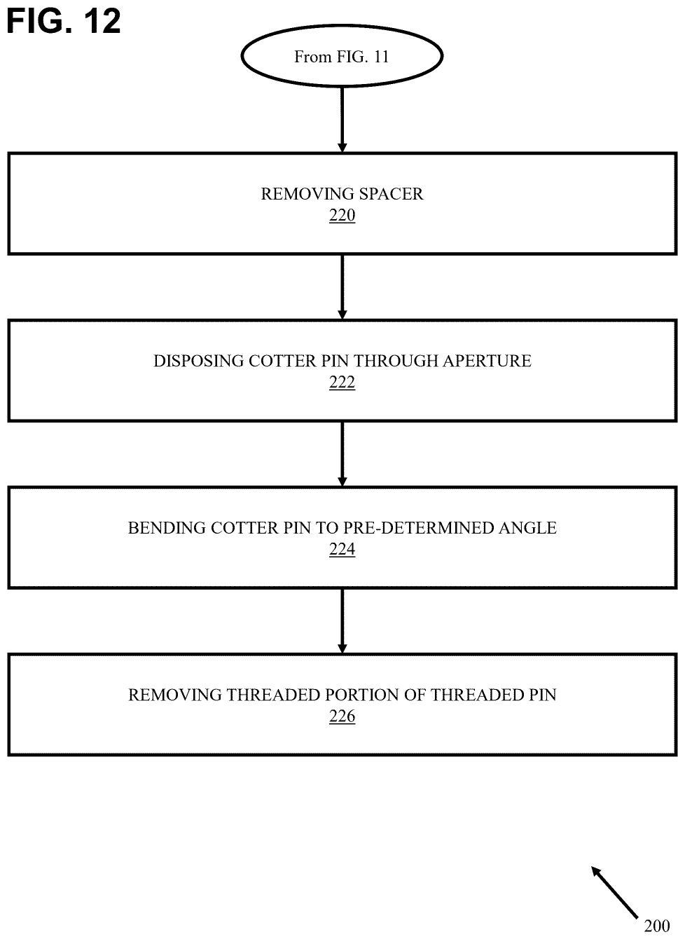

With reference to FIGS. 10, 11, and 12, a method 200 of coupling a first link 12 of a chain 10 to a second link 14 of the chain 10, the first link 12 including a barrel 24, a first barrel aperture 26a and a second barrel aperture 26b, and the second link 14 including a first aperture 28a and a second aperture 28b is provided. The method 200 can include a step 202 of providing a threaded pin assembly 100 as described hereinabove. The method 200 can include a step 204 of aligning the barrel apertures 26a, 26b of the second link 14 and the first aperture 28a and the second aperture 28b of the first link 12. The method 200 can include a step 206 of inserting the threaded pin 102 through the barrel 24, barrel apertures 26a, 26b of the second link 14 and the first aperture 28a and the second aperture 28b of the first link 12. The method 200 can include a step 208 of disposing the spacer 134 on the threaded pin 102. The method 200 can include a step 210 of disposing the thrust washer 142 on the threaded pin 102. The method 200 can include a step 212 of threadably engaging the threaded fastener 144 with the threaded pin 102. The method 200 can include a step 214 of tightening the threaded fastener 144 on the threaded pin 102. The step 214 of tightening the threaded fastener 144 can result in the threaded pin 102 being pulled through the first aperture 28a and the second aperture 28b of the second link 14, the barrel 24, the first barrel aperture 26a, and the second barrel aperture 26b of the first link 12 until the head 104 substantially abuts one of the first aperture 28a and the second aperture 28b of the first link 12. As the threaded pin 102 is pulled through the first aperture 28a and the second aperture 28bof the second link 14, the barrel 24, the first barrel aperture 26a, and the second barrel aperture 26b of the first link 12, the spacer 134 can be pushed until it confronts a surface around the other of the first aperture 28a and second aperture 28b of the first link 12. The step 214 of tightening can be accomplished using an impact driver paired with an impact-rated deep well socket.

In certain embodiments, the method 200 can further include a step 216 of threadably disengaging the threaded fastener 144 with the threaded pin 102. The method 200 can include a step 218 of removing the thrust washer 142. The method 200 can include a step 220 of removing the spacer 134. The method 200 can further include a step 222 of disposing the cotter pin 132 through the aperture 130 of the threaded pin 102. The method 200 can include a step 224 of bending the cotter pin 132 to a pre-determined angle. The method 200 can include a step 226 of removing the threaded portion 108 of the threaded pin 102. The step 226 of removing the threaded portion can allow for better clearance, militating against interference with surrounding equipment or adjacent chain components. By eliminating excess length, the risk of snagging, obstruction, or unintended contact with moving parts can be reduced.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A threaded pin assembly for a chain having a first link and a second link, the first link including a barrel, a first barrel aperture, and a second barrel aperture, and the second link including a first aperture and a second aperture, the threaded pin assembly comprising:
a threaded pin having a head at a first end, a threaded portion at a second end, a body portion disposed between the head and the threaded portion, and a pin shoulder disposed between the body portion and the threaded portion;
a spacer configured to be disposed on the threaded pin from the second end, the spacer including a tapered aperture configured to abut the pin shoulder of the threaded pin and limit travel of the spacer on the threaded pin toward the head;
a thrust washer configured to be disposed on the threaded pin from the second end; and
a threaded fastener configured to threadably engage the threaded portion.

2. The threaded pin assembly of claim 1, wherein the threaded pin includes a swell neck disposed between the head and the body portion.

3. The threaded pin assembly of claim 1, wherein a length of the body portion is substantially the same as a length of a passageway formed by the barrel, the first barrel aperture, and the second barrel aperture of the first link, and the first aperture and the second aperture of the second link.

4. The threaded pin assembly of claim 1, wherein a diameter of the body portion is substantially the same as the diameter of one of the first aperture and the second aperture.

5. The threaded pin assembly of claim 1, wherein the pin shoulder includes a tapered transition from a first diameter to a second diameter, the second diameter smaller than the first diameter.

6. The threaded pin assembly of claim 5, wherein the threaded portion includes a diameter substantially the same as the second diameter of the pin shoulder.

7. The threaded pin assembly of claim 1, wherein the threaded pin includes an aperture configured to receive a cotter pin.

8. The threaded pin assembly of claim 7, wherein the aperture is disposed on the pin shoulder of the threaded pin.

9. The threaded pin assembly of claim 1, wherein the head includes a diameter larger than a diameter of one of the first aperture and the second aperture of the second link.

10. The threaded pin assembly of claim 1, wherein the tapered aperture is formed by an aperture of the spacer tapering from a first diameter to a second diameter, the second diameter is smaller than the first diameter.

11. The threaded pin assembly of claim 5, wherein the tapered aperture abuts the tapered transition of the pin shoulder.

12. The threaded pin assembly of claim 1, wherein the threaded pin includes a relief groove formed on the threaded portion.

13. The threaded pin assembly of claim 1, wherein the threaded pin includes a coating configured to reduce friction and heat generated by the threaded pin being pulled through one of the first barrel aperture, and the second barrel aperture of the second link and the first aperture and the second aperture of the first link.

14. The threaded pin assembly of claim 13, wherein the coating comprises a member selected from a group consisting of: molybdenum disulfide, grease, graphite, polytetrafluoroethylene, boron nitride, tungsten disulfide, and combinations thereof.

15. A chain comprising:
a first link including a barrel, a first barrel aperture, and a second barrel aperture;
a second link including a first aperture and a second aperture;
a threaded pin having a head at a first end, a threaded portion at a second end, a swell neck disposed adjacent the head, a body portion disposed between the swell neck and the threaded portion, and a pin shoulder disposed between the body portion and the threaded portion, the pin shoulder including an aperture configured to receive a cotter pin;
a spacer configured to be disposed on the threaded pin from the second end, the spacer including a tapered aperture configured to abut the pin shoulder of the threaded pin and limit travel of the spacer on the threaded pin toward the head;
a thrust washer configured to be disposed on the threaded pin from the second end; and
a threaded fastener configured to threadably engage the threaded portion,
wherein:
the threaded pin is configured to be received through the first barrel aperture, the barrel, and the second barrel aperture of the first link and the first aperture and the second aperture of the second link, the first barrel aperture, the barrel, and the second barrel aperture disposed between the first aperture and the second aperture, the threaded pin coupling the first link and the second link, and
the swell neck fits in one of the first aperture and the second aperture of the second link and an end of the spacer confronts a surface around the other of the first aperture and the second aperture of the second link.

16. A method for coupling a first link of a chain to a second link of the chain, the first link including a barrel, a first barrel aperture, and a second barrel aperture, and the second link including a first aperture and a second aperture, the method comprising:
providing a threaded pin assembly including:
a threaded pin having a head at a first end, a threaded portion at a second end, a body portion disposed between the head and the threaded portion, and a pin shoulder disposed between the body portion and the threaded portion;
a spacer configured to be disposed on the threaded pin from the second end, the spacer including a tapered aperture configured to abut the pin shoulder of the threaded pin and limit travel of the spacer on the threaded pin toward the head;
a thrust washer configured to be disposed on the threaded pin from the second end; and
a threaded fastener configured to threadably engage the threaded portion;
aligning the first barrel aperture and the second barrel aperture of the second link and the first aperture and the second aperture of the first link and inserting the threaded pin therethrough;
disposing the spacer on the threaded pin;
disposing the thrust washer on the threaded pin;
threadably engaging the threaded fastener with the threaded pin; and
tightening the threaded fastener on the threaded pin.

17. The method of claim 16, wherein the tightening of the threaded fastener results in the threaded pin being pulled through the barrel, the first barrel aperture, and the second barrel aperture of the first link until the head substantially abuts one of the first aperture and the second aperture of the second link.

18. The method of claim 16, further comprising:
threadably disengaging the threaded fastener;
removing the thrust washer;
removing the spacer;
disposing a cotter pin through an aperture; and
bending the cotter pin.

19. The method of claim 18, further comprising:
removing the threaded portion of the threaded pin.

20. A chain including a first link coupled to a second link according to the method of claim 18.
